(19) United States
(12) Patent Application Publication
(10) Pub. No.: US 2012/0146919 A1
(43) Pub. Date: Jun. 14, 2012

(54) TOUCH SCREEN PANEL

(76) Inventors: Hwa-Young Kim, Yongin-city (KR); Sang-Kook Kim, Yongin-city (KR)

(21) Appl. No.: 13/051,901

(22) Filed: Mar. 18, 2011

(30) Foreign Application Priority Data
Dec. 10, 2010 (KR) 10-2010-0126307

(51) Int. Cl. G06F 3/041

(52) U.S. Cl. 345/173

(57) ABSTRACT

A touch screen panel includes: a substrate; a plurality of sensing electrodes on a first side of the substrate; a shield electrode on a second side of the substrate; a flexible circuit board electrically connected to a driving circuit, the flexible circuit board being attached to the first side of the substrate, and having a via hole; a connection pad on a second side of the flexible circuit board and electrically connected to the driving circuit through the via hole; and a conductive member electrically connecting the connection pad with the shield electrode.

### CROSS-REFERENCE TO RELATED APPLICATION

This application claims priority to and the benefit of Korean Patent Application No. 10-2010-0126307, filed on Dec. 10, 2010, in the Korean Intellectual Property Office, the entire content of which is incorporated herein by reference.

### BACKGROUND

1. Field

One embodiment of the present invention relates to a touch screen panel.

2. Description of Related Art

Touch screen panels are input devices that can be used to detect the selection of content displayed on the screen of an image display device, for example, using a person's hand or an object to input user commands.

To this end, the touch screen panels are provided on a front side of the image display device and convert positions where a person's hand or an object directly contacts the touch screen panels into electrical signals. Accordingly, an instruction selected at the contact point is received as an input signal.

As the touch screen panels can replace separate input devices such as a keyboard and a mouse that are typically connected to the image display device, the use of the touch screen panels is gradually expanding.

Various systems and methods of implementing touch screen panels such as a resistive type, a light sensing type, and a capacitive type, etc. are known.

Among the types of touch screen panels, the capacitive touch screen panel includes a plurality of sensing electrodes distributed in a touch active area and determines the point of contact by detecting a point where electrostatic capacitance changes (e.g., a localized change in electrostatic capacitance) when a person's hand or an object contacts.

### SUMMARY

Embodiments of the present invention are directed to a touch screen panel that makes it possible to simplify a process of pressing a flexible circuit board and reducing or preventing a defect of the flexible circuit substrate.

One embodiment of the present invention provides a touch screen panel including: a substrate; a plurality of sensing electrodes on a first side of the substrate; a shield electrode on a second side of the substrate; a flexible circuit board electrically connected to a driving circuit, the flexible circuit board being attached to the first side of the substrate, and having a via hole; a connection pad on a second side of the flexible circuit board and electrically connected to the driving circuit through the via hole; and a conductive member electrically connecting the connection pad with the shield electrode.

The driving circuit may be on a first side of the flexible circuit board.

The conductive member may include a conductive tape.

The conductive member may include a carbon paste.

The shield electrode may be formed over an entire portion of the second side of the substrate.

The substrate may further include a pad unit on the substrate, the pad unit being connected with the sensing electrodes through a plurality of driving wires on the first side of the substrate, wherein the flexible circuit board may be electrically connected to the pad unit.

The shield electrode include a transparent conductive material.

As described above, according to embodiments of the present invention, it is possible to provide a touch screen panel that makes it possible to simplify a process of pressing a flexible circuit board and reduce or prevent a defect that may be generated by the flexible circuit board.

### BRIEF DESCRIPTION OF THE DRAWINGS

The accompanying drawings, together with the specification, illustrate exemplary embodiments of the present invention, and, together with the description, serve to explain the principles of the present invention.

FIGS. 1A, 1B, and 1C are plan views showing a typical flexible circuit board.

FIG. 2 is a plan view showing a first side of a substrate according to a first embodiment of the present invention.

FIG. 3A is a plan view showing the first side of a substrate where the flexible circuit board is attached according to the first embodiment of the present invention.

FIG. 3B is a plan view showing the second side of a substrate where the flexible circuit board is attached according to the first embodiment of the present invention.

FIG. 3C is a plan view showing where a conductive tape is attached in FIG. 3B according to the first embodiment of the present invention.

FIG. 3D is a cross-sectional view taken along the line A-B in FIG. 3C according to the first embodiment of the present invention.

FIG. 4A is a view showing the second side of a substrate where a carbon paste is attached according to a second embodiment of the present invention.

FIG. 4B is a cross-sectional view taken along the line C-D in FIG. 4A according to the second embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

The details of embodiments are included in the detailed specification and the drawings.

Aspects and features of the present invention and methods to achieve them will be clear from exemplary embodiments described below in detail with reference to the accompanying drawings. However, the present invention is not limited to the embodiment described hereafter and may be implemented in various ways. Further, connection of a part with another part includes direct connection and electrical connection of the parts with another device therebetween. Further, some of the parts not related to embodiments of the present invention are omitted in order to make the description of the present invention more clear.

Hereinafter, embodiments of the present invention are described with reference to the accompanying drawings.

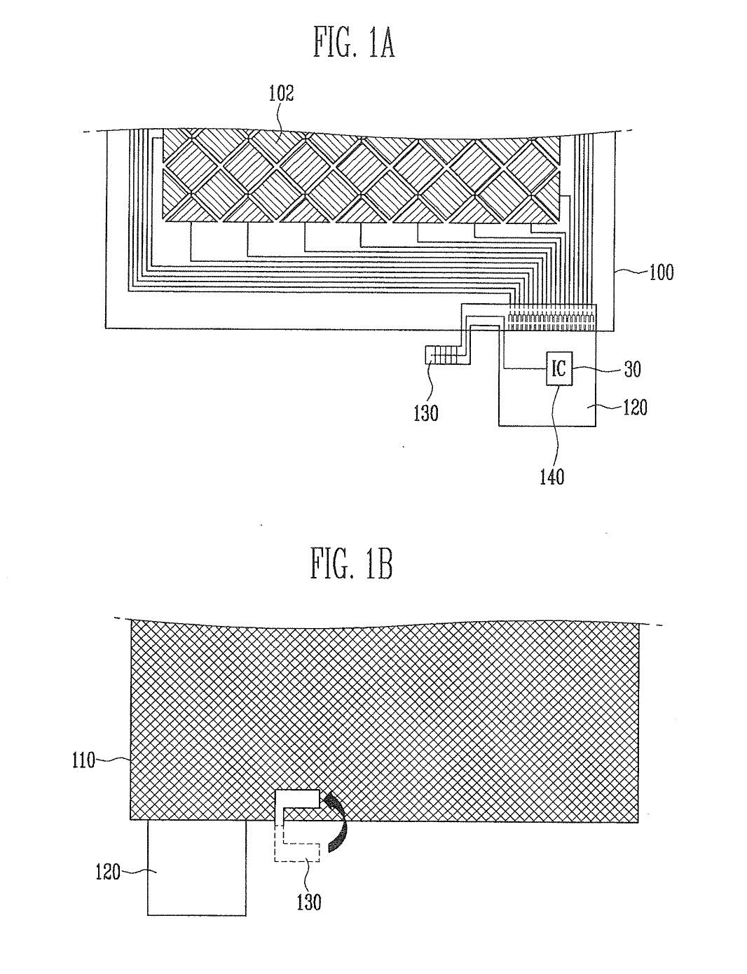

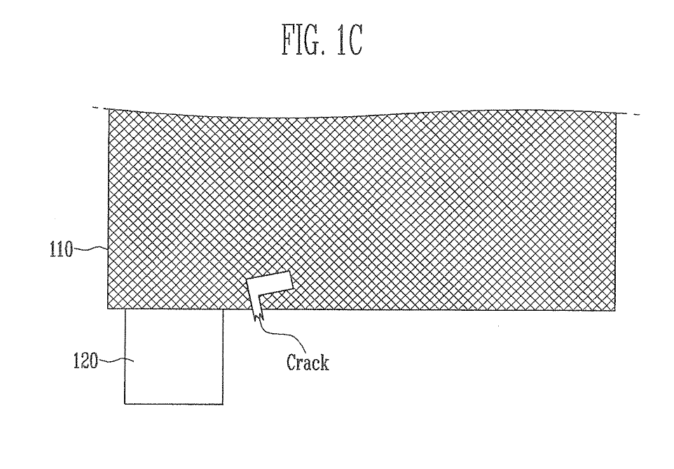

FIGS. 1A, 1B, and 1C are views showing a typical flexible circuit board. Referring to the figures, the sensing electrodes 102 are distributed on a first side of a substrate 100, for example, on the first (e.g., front) side.

A shield electrode 110 is formed on the other (e.g., second) side of the substrate 100, for example, on the second (e.g., rear) side.

The shield electrode 110 functions as a conductive shield that blocks external noise from coming inside, by being connected to a substantially constant voltage source, such as a ground power source.

In order to connect the sensing electrodes 102 and the shield electrode 110 on both sides of the substrate 100 to a driving circuit 140, a main Flexible Printed Circuit Board (FPCB) 120 was attached to the first (e.g., front) side of the substrate 100 (FIG. 1A) and an individual (or separate) shield FPCB 130 connected to the main FPCB 120 was provided and bent to be attached to the second (e.g., rear) side of the substrate 100 in the related art.

However, this case has a problem in that it is required to perform pressing twice in the manufacturing process, the shield FPCB 130 might be attached at an angle on the second (e.g., rear) side of the substrate 100, as shown in FIG. 10, and cracks may be frequently created at the bending portion.

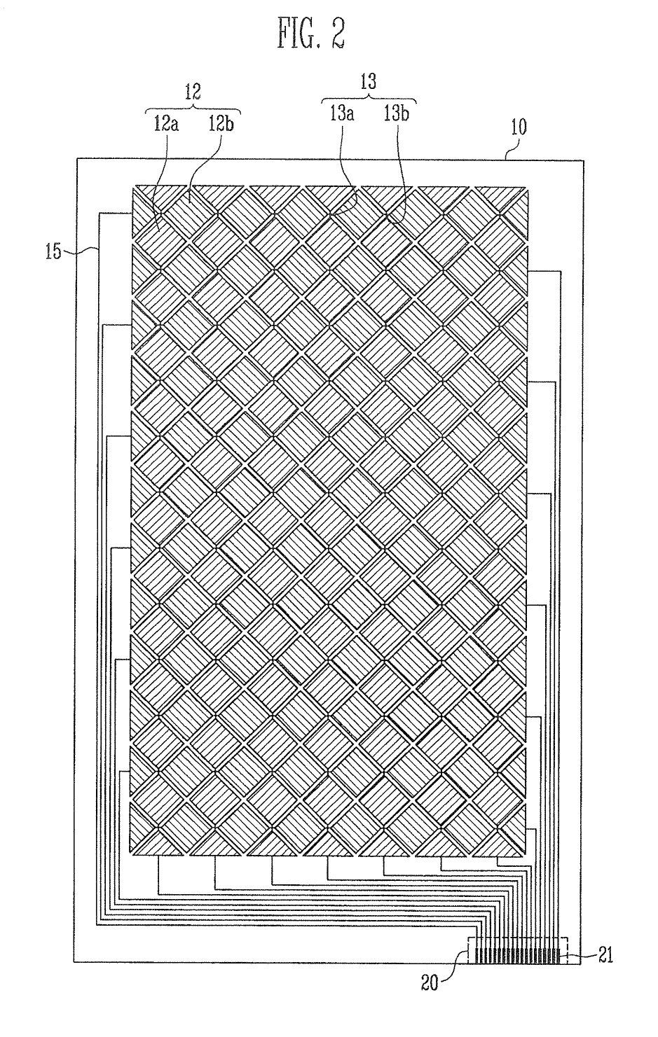

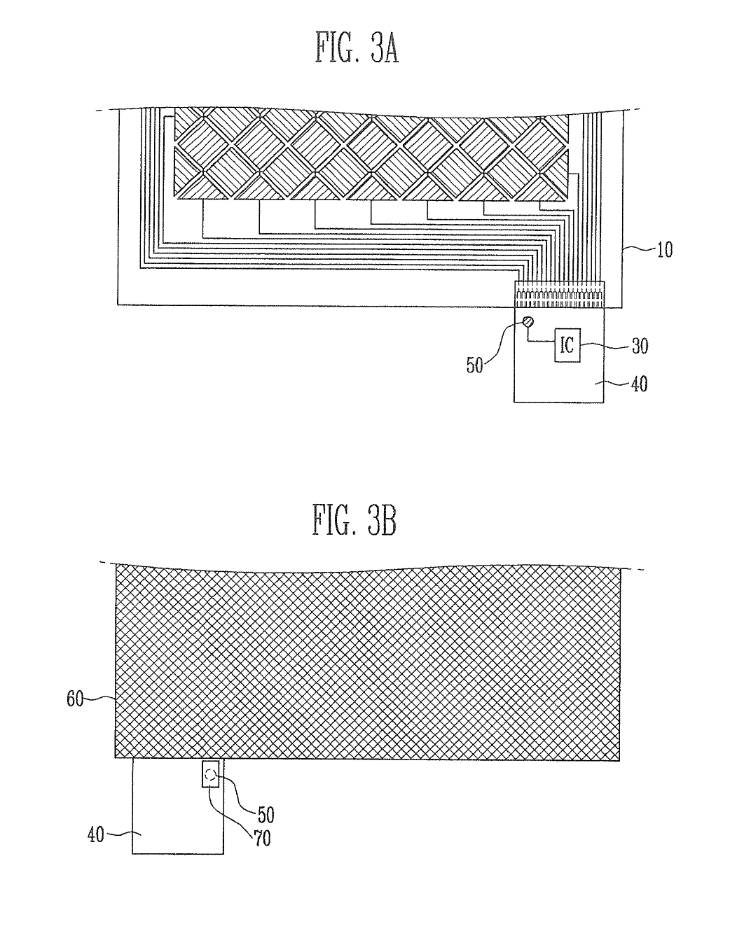

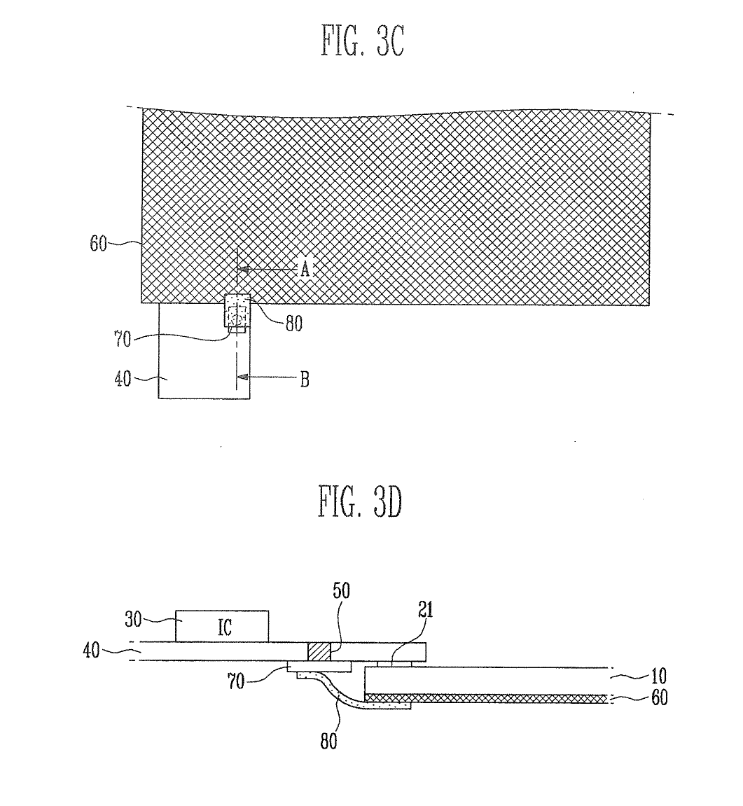

FIG. 2 is a plan view showing a first (e.g., front) side of a substrate according to a first embodiment of the present invention and FIG. 3A is a plan view showing the first side of a substrate where the flexible circuit board is attached according to the first embodiment of the present invention. FIG. 3B is a plan view showing the second (e.g., rear) side of a substrate where the flexible circuit board is attached according to the first embodiment of the present invention, FIG. 3C is a plan view showing where a conductive tape is attached in FIG. 3B according to the first embodiment of the present invention, and FIG. 3D is a cross-sectional view taken along the line A-B in FIG. 3C according to the first embodiment of the present invention. In particular, for the convenience of description in FIG. 3D, a flexible circuit board 40 is referred to as being disposed at the upper portion, based on the orientation of the figure.

As illustrated in FIGS. 3A, 3B, 3C, and 3D, a touch screen panel according to one embodiment of the present invention includes a substrate 10, a flexible circuit board 40, a connection pad 70, and a conductive member 80.

The substrate 10 is a transparent substrate with a plurality of sensing electrodes 12 on the first side, and, for example, may be made of an insulating material, such as glass, plastic, silicon, or synthetic resin, and may be flexible.

Further, a shield electrode 60 is formed on the second (e.g., rear) side of the substrate 10.

The sensing electrodes 12 may be formed in various ways, and in one embodiment, are arranged as shown in FIG. 2.

Referring to FIG. 2, the sensing electrodes 12 are distributed in a touch active area of the substrate 10 and connected in a first direction or a second direction. The touch active area, for example, may be set as a display area, e.g., in which the touch active area may be an area that overlaps pixels (e.g., all of the pixels) on a display panel under the touch screen panel.

In more detail, in one embodiment, the sensing electrodes 12 include a plurality of first sensing electrodes 12a connected in the first direction on the first side of the substrate and a plurality of second sensing electrodes 12b distributed between the first sensing electrodes 12a, alternately with the first sensing electrodes 12a, and connected in the second direction crossing (e.g. perpendicular to) the first direction.

That is, in one embodiment, the first sensing electrodes 12a are arranged in rows or columns, and the first sensing electrodes 12a arranged in the same row or column (e.g., in the same column in one embodiment) are connected in the first direction (e.g., in the column direction in this embodiment) by first connection patterns 13a arranged in the same row or column. In this configuration, the first sensing electrodes 12a are connected with the driving wires 15 in the lines connected in the first direction.

Further, in one embodiment, the second sensing electrodes 12b are arranged in rows or columns, and the second sensing electrodes 12b arranged in the same row or column (e.g., in the same row in one embodiment) are connected in the second direction (e.g., in the row direction in this embodiment) by second connection patterns 13b arranged in the same row or column. In this configuration, the second sensing electrodes 12b are connected with the driving wires 15 in the lines connected in the second direction.

In one embodiment of the present invention, the first sensing electrodes 12a and the second sensing electrodes 12b are made of a transparent material having a transmittance (e.g., a predetermined transmittance), in order to transmit light emitted from a display panel disposed thereunder. For example, the first sensing electrodes 12a and the second sensing electrodes 12b may be made of transparent conductive materials, such as ITO (Indium Tin Oxide), IZO (Indium Zinc Oxide), CNT (Carbon Nano Tube), and graphene.

The connection patterns 13 include a plurality of the first connection patterns 13a formed in the first direction between the first sensing electrodes 12a to connect the first sensing electrodes 12a in the first direction and a plurality of second connection patterns 13b formed in the second direction between the second sensing electrodes 12b to connect the second sensing electrodes 12b in the second direction.

As shown in the embodiment of FIG. 3B, the shield electrode 60 is located on the second (e.g., rear) side of the substrate 10 and may be connected to a constant voltage supply, such as a ground power supply, to reduce or prevent external noise from coming inside.

The shield electrode 60 may be made of a transparent conductive material, similar to the sensing electrodes 12, and may be formed throughout (e.g., over an entire portion of) the second (e.g., rear) side of the substrate 10 to increase the effect of reducing or preventing external noises.

As shown in the embodiment of FIG. 3A, the flexible circuit board 40 is electrically connected to a driving circuit 30 and attached to the first side of the substrate 10.

Further, the flexible circuit board 40 has a via hole 50 that is formed through the flexible circuit board 40 and that electrically connects the driving circuit 30 with the connection pad 70 (see, e.g., FIG. 3B), to electrically connect the driving circuit 30 with the shield electrode 60.

Referring to FIG. 3B, the connection pad 70 on the second side of the flexible circuit board 40 is electrically connected with the driving circuit 30 through the via hole 50.

Further, as shown in the embodiment of FIG. 3C, the conductive member 80 electrically connects the connection pad 70 with the shield electrode 60 by being attached to the connection pad 70 and the shield electrode 60.

Therefore, the shield electrode 60 may be electrically connected to the driving circuit 30 through the via hole 50 and the connection pad 70 without using an individual (or separate) shield FPCB 130, even though the driving circuit 30 is on the first side of the flexible circuit board 40 and the shield electrode 60 is on the second (e.g., rear) side of the flexible circuit board 40.

In one embodiment, the flexible circuit board 40 and the substrate 10 are bonded together by an ACF (Anisotropic Conductive Film), in which the ACF has a structure in which conductive balls, which are conductive spheres covered by a thin insulating layer, are distributed on an adhesive resin. The conductive balls of the ACF are broken and bonded (e.g., to the surfaces contacting them) under pressure.

Therefore, embodiments of the present invention may be assembled in a reduced number of presses using the ACF on the first side of the substrate 10, such that process of manufacturing can be simplified.

Further, it is possible to reduce or prevent inclination or cracks that may be formed when the individual (e.g., separate) shield FPCB 130 is provided.

In one embodiment of the present invention, the conductive member 80 is a conductive tape and it is possible to electrically connect the connection pad 70 with the shield electrode 60 by using the conductive tape. FIGS. 3C and 3D illustrate an embodiment in which conductive tapes are used for the conductive members 80.

The driving circuit 30 determines the point of contact by detecting a change in electrostatic capacitance which is generated in the sensing electrodes 12 when an object, such as a person's hand or a stylus pen comes in contact with the touch screen panel and controls power that is supplied to the shield electrode 60 through the electrical connection with the shield electrode 60.

Furthermore, although the driving circuit 30 is shown in FIGS. 3A and 3D as being formed on the first side of the flexible circuit substrate 40, in some embodiments it may be disposed in another individual (e.g., separate) space in which can be electrically connected with the shield electrode 60.

Therefore, in one embodiment, a pad unit 20 that includes: driving wires 15 connected with respective ones of the first sensing electrodes 12a and the second sensing electrodes 12b in the lines connected in the first direction and the second direction; and a plurality of pads 21 electrically connected with the sensing electrodes 12 through the driving wires 15 is formed on the substrate 10 in order to implement the electrical connection between the sensing electrodes 12 and the driving circuit 30.

According to one embodiment of the present invention, the driving wires 15 are not in the touch active area in which an image may be displayed, but in a touch non-active area (e.g. non-display area) which is outside of the edges of the touch active area, such that the a wide range of materials may be used in the driving lines 15. The driving wires 15 may be made of low-resistance materials such as Mo, Ag, Ti, Cu, Al, and Mo/Al/Mo, in addition to transparent conductive materials similar to those used for the sensing electrodes 12.

Therefore, the flexible circuit substrate 40 can be electrically connected with the sensing electrodes 12 by being pressed with the pad unit 20 on the first side of the substrate 10.

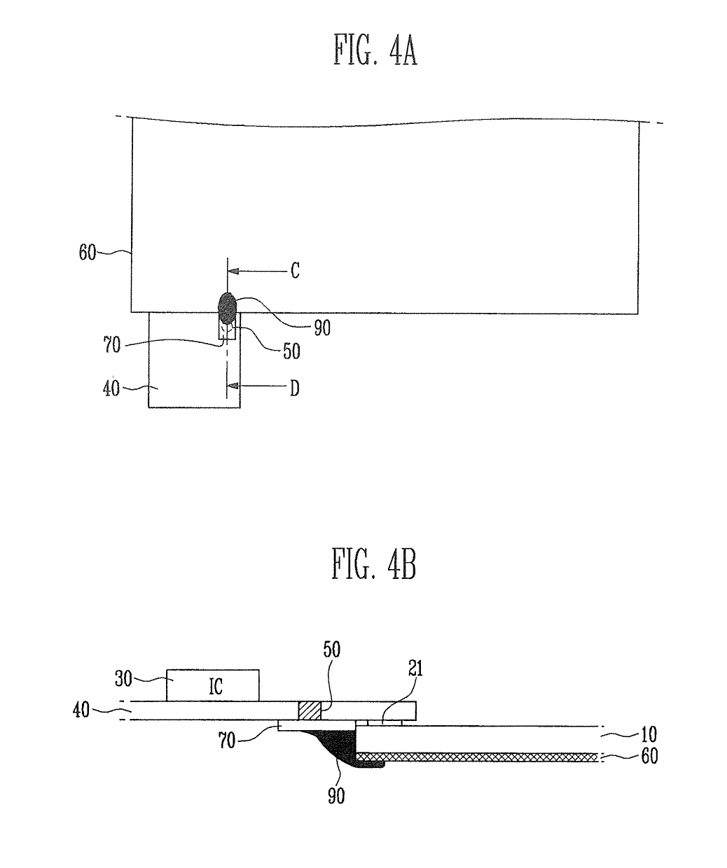

FIG. 4A is a plan view showing the second (e.g., rear) side of a substrate in which a carbon paste according to a second embodiment of the present invention is attached and FIG. 4B is a cross-sectional view taken along the line C-D in FIG. 4A. In particular, for the convenience of description in FIG. 4D, a flexible circuit board 40 is referred to as being disposed at the upper portion, based on the orientation of the figure.

Referring to FIGS. 4A and 4B, a touch screen panel according to the second embodiment of the present invention includes a carbon paste 90 in place of (or in addition to) the conductive member 80 of the first embodiment of the present invention. Therefore, the configuration is substantially the same as that of the first embodiment described above and the detailed description of similar components is not provided.

The carbon paste 90 is applied on the connection pad 70 and the shield electrode 60, electrically connecting the connection pad 70 with the shield electrode 60 in a manner similar to that of the conductive tape, as described in connection with the first embodiment.

Therefore, it is possible to electrically connect the shield electrode 60 with the driving circuit 30 through the via hole 50 and the connection pad 70 without using the individual (e.g., separate) shield FPCB 130, and it is possible to electrically connect the connection pad 70 with the shield electrode 60 by using the carbon paste 90.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel comprising:
a substrate;
a plurality of sensing electrodes on a first side of the substrate;
a shield electrode on a second side of the substrate;
a flexible circuit board electrically connected to a driving circuit, the flexible circuit board being attached to the first side of the substrate and having a via hole;
a connection pad on a second side of the flexible circuit board and electrically connected to the driving circuit through the via hole; and
a conductive member electrically connecting the connection pad with the shield electrode.

2. The touch screen panel according to claim 1, wherein the driving circuit is on a first side of the flexible circuit board.

3. The touch screen panel according to claim 1, wherein the conductive member comprises a conductive tape.

4. The touch screen panel according to claim 1, wherein the conductive member comprises a carbon paste.

5. The touch screen panel according to claim 1, wherein the shield electrode is formed over an entire portion of the second side of the substrate.

6. The touch screen panel according to claim 1, further comprising a pad unit on the substrate, the pad unit being connected with the sensing electrodes through a plurality of driving wires on the first side of the substrate,
wherein the flexible circuit board is electrically connected to the pad unit.

7. The touch screen panel according to claim 1, wherein the shield electrode comprises a transparent conductive material.
